(19) United States
(12) Patent Application Publication
(10) Pub. No.: US 2014/0053144 A1
(43) Pub. Date: Feb. 20, 2014

(54) SERVICE ENVIRONMENT UPGRADES BASED ON UPGRADE HEALTH OF SERVICE UNITS

(71) Applicants: Tittu Jose, Redmond, WA (US); Janak Agarwal, Redmond, WA (US); Hardik Shah, Seattle, WA (US); Maxim Lukiyanov, Redmond, WA (US); Stephen Clark, Bellevue, WA (US); Tarkan Sevilmis, Redmond, WA (US); Sreekanth Lingannapeta, Redmond, WA (US); Arshish Kapadia, Issaquah, WA (US); Gheorghita Irimescu, Sammamish, WA (US)

(72) Inventors: Tittu Jose, Redmond, WA (US); Janak Agarwal, Redmond, WA (US); Hardik Shah, Seattle, WA (US); Maxim Lukiyanov, Redmond, WA (US); Stephen Clark, Bellevue, WA (US); Tarkan Sevilmis, Redmond, WA (US); Sreekanth Lingannapeta, Redmond, WA (US); Arshish Kapadia, Issaquah, WA (US); Gheorghita Irimescu, Sammamish, WA (US)

(73) Assignee: MICROSOFT CORPORATION, Redmond, WA (US)

(21) Appl. No.: 13/585,045

(22) Filed: Aug. 14, 2012

(51) Int. Cl. G06F 9/44

(52) U.S. Cl. 717/168

(57) ABSTRACT

Disclosed herein are systems, methods, and software for facilitating technology upgrades. In at least one implementation, an incomplete upgrade to service units within a service environment is initiated. An upgrade health of each of the service units is evaluated based at least in part on results of the incomplete upgrade. A complete upgrade of the service environment is then initiated based at least in part on the upgrade health of each of the plurality of service units.

### TECHNICAL FIELD

Aspects of the disclosure are related to computing and communication technologies and in particular to upgrade technologies for service environments.

### TECHNICAL BACKGROUND

Implementing software upgrades within data centers and other computing facilities can be a time consuming and resource intensive task. The demands made on such software, such as limited or zero downtime, create even more challenges when upgrading. A great deal of coordination amongst infrastructure elements, physical resources, personnel, and other aspects of data center operations has been required to meet these demands.

The basic complexity of many data center environments only increases the challenges posed by upgrades. Data centers typically include infrastructure elements, such as power supply, communication connections, environmental controls, and security. In addition, physical resources and virtual resources are deployed to run the software installed therein, such as servers, routers, dedicated storage elements, and virtual machines. Lack of coordination may hinder both upgrade and normal data center operations.

For example, at least some upgrades necessitate the deployment of additional virtual machines within a service environment. Upgraded software may then be implemented on the additional virtual machines. However, the underlying physical machines that host the additional virtual machines may not have sufficient capacity for the load taken on when deploying virtual machines or upgraded software. If sufficiently coordinated, it may be possible to reserve the physical machines to handle the upgrade load, although insufficient coordination can result sub-optimal performance.

### Overview

Provided herein are systems, methods, and software for facilitating technology upgrades. In at least one implementation, an incomplete upgrade to service units within a service environment is initiated. An upgrade health of each of the service units is evaluated based at least in part on results of the incomplete upgrade. A complete upgrade of the service environment is then initiated based at least in part on the upgrade health of each of the plurality of service units.

This Overview is provided to introduce a selection of concepts in a simplified form that are further described below in the Technical Disclosure. It should be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates an upgrade scenario in an implementation.

FIG. 2 illustrates an upgrade process in an implementation.

FIG. 3 illustrates a computing system in an implementation.

FIG. 4 illustrates a data center in an implementation.

FIG. 5 illustrates an upgrade process in an implementation.

### TECHNICAL DISCLOSURE

Implementations described herein provide for enhanced upgrade technologies. In some implementations, software to be upgraded may include service units. Incomplete or partial upgrades, sometimes referred to as dry runs, are performed with respect to the service units in order to determine their respective readiness for an upgrade. The actual, complete upgrade may then be scheduled based on the health of each of the service units and initiated accordingly. The incomplete upgrade may include a subset of upgrade tasks included in the complete upgrade. In some implementations, the incomplete upgrade may itself be sequenced or scheduled based on results of previous incomplete upgrades. However, switching live traffic to the cloned service units may be included in the complete upgrade, but not included in the incomplete upgrade. In some implementations at least some of the service units may be cloned during the incomplete or complete upgrades.

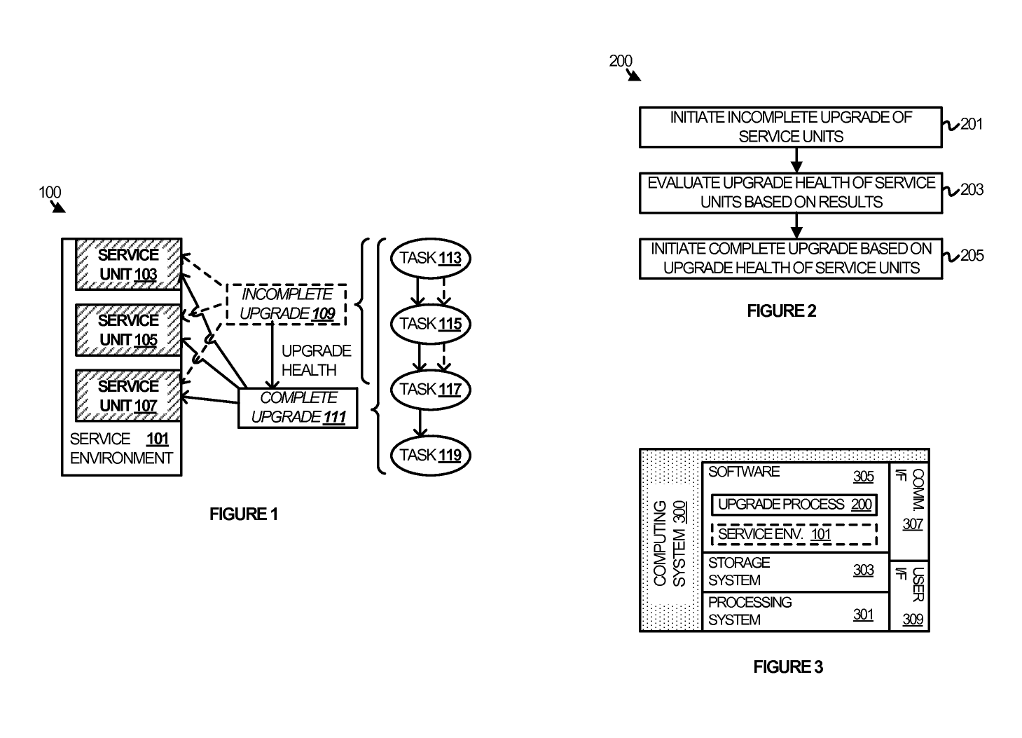

Turning now to FIG. 1, upgrade scenario 100 illustrates upgrade operations when upgrading service environment 101. The following discussion of FIG. 1 will make parenthetical reference to the steps illustrated by upgrade process 200 for purposes of clarity. Note the additional steps may be considered within the scope of this disclosure.

In particular, upgrade scenario 100 involves an upgrade to service unit 103, service unit 105, and service unit 107 within service environment 101. An incomplete upgrade 109 is performed, the results of which are used to determine the upgrade health of service unit 103, service unit 105, and service unit 107. A complete upgrade 111 is then initiated based on the upgrade health of the service units.

Service environment 101 includes service unit 103, service unit 105, and service unit 107. Service environment 101 may be any system, collection of systems having sub-systems or software therein that, from time to time, may be upgraded. While a data center is one example of service environment 101, other examples include other systems of greater or lesser scale, including multiple data centers, sub-sections or sub-systems within a data center, server racks, and servers, as well as any combination or variation thereof.

Accordingly, service unit 103, service unit 105, and service unit 107 may each be any sub-system or software within a service environment capable of being upgraded. Examples of service unit 103, service unit 105, and service unit 107 include application software, operating system software, virtual machines, and physical machines, as well as any combination or variation thereof.

In operation, incomplete upgrade is 109 is initiated that involves only a subset of upgrade tasks, including task 113, task 115, and task 117 (step 201). Examples of upgrade tasks include provisioning physical components, provisioning virtual components, provisioning databases, cloning elements, backing up data, installing or otherwise provisioning the upgraded version of the software or hardware component being upgraded, and activating the upgraded component, such as by shifting live traffic to the upgrade component. Other upgrade tasks are possible and the scope of the present disclosure is not limited to just those tasks disclosed herein for illustrative purposes.

An upgrade health of each of service unit 103, service unit 105, and service unit 107 is evaluated based on the results of incomplete upgrade 109 (step 203). The upgrade health may be determined based on a variety of factors, such as the ability for each of task 113, task 115, and task 117 to be completed successfully, partially, or not at all with respect to each service unit. Other factors may include the progress made against each task or the difficulty of completing each task when obstacles to its completion are encountered. A variety of indicators may be used to represent the upgrade health for each service unit, such as an alphanumeric representation, as well as any other suitable indicator.

In at least one implementation, a numeric score is calculated for each service unit that represents the health of the service unit with respect to potential upgrades. Each of the subset of tasks, task 113, task 115, and task 117, is assigned a factor. The factor for at least one of the tasks may then be weighted, such that a sum or product of the tasks provides a score that can be compared against similar scores calculated for other service units. In another implementation, each task is assigned a score within a range based on the progress made towards completing each task. The scores may again be summed or multiplied and the sum or product provided as representative of the health of the subject service unit, comparable to other metrics for other service units. Note that other scores and ways to determine scores are possible and are not limited to those disclosed herein. Rather, a wide variety of scoring mechanisms, weighting mechanism, or measuring mechanisms, as well as any combination or variation thereof, may be deployed allowing for a readiness comparison between service units with respect to upgrades. In addition, the complexity of a given service unit or upgrade task can be a factor in calculating a health score, as well as the progress made towards the complex unit or task.

The upgrade health of each of service unit 103, service unit 105, and service unit 107 is used to sequence or otherwise schedule complete upgrade 111. By intelligently ordering the actual upgrade to service unit 103, service unit 105, and service unit 107 based on their respective upgrade health, the overall time and personnel needed to perform the upgrade may be reduced.

In some cases, incomplete upgrade 109 may be carried out periodically, continuously, or at some other interval, allowing for troubleshooting and other maintenance activities against the service units well ahead of when an actual, complete upgrade may be called for. In this manner, the service units 103, 105, and 107 within service environment 101 may enjoy a state of readiness with respect to upgradability that allows for actual upgrades to be carried out relatively quickly and with less error, thereby fulfilling the demands of an overarching service provided by the service units, such as limited downtime. Moreover, even if though other errors or unforeseen obstacles may occur when executing complete upgrade 111, by scheduling complete upgrade 111 based on the upgrade readiness of service unit 103, service unit 105, and service unit 107, the likelihood of encountering debilitating obstacles can be reduced. In some implementations, errors can be fixed before a complete upgrade is initiated.

Eventually, complete upgrade 111 is initiated based on the health of each service unit (step 205), which in this scenario involves all of the upgrade tasks, task 113, task 115, task 117, and task 119. Task 119 may be any task that is not included in the subset of tasks performed by incomplete upgrade 111. In one example, task 119 involves switching live traffic to the upgraded version or portion of the service unit or other system or component having been upgraded, or otherwise activating the upgraded version or portion.

Note that while upgrade process 200 generally refers to initiating an incomplete upgrade and initiating a complete upgrade, variations of upgrade process 200 are possible. For example, a variation of upgrade process 200 may include carrying out the incomplete upgrade and carrying out the complete upgrade. As such, upgrade process 200 may be implemented in a wide variety of computing systems represented by computing system 300 in FIG. 3.

For example upgrade process 200 may be implemented on a computing system deployed within a systems control environment that is capable of monitoring service environment 101 and performing upgrade process 200. In other words, the computing system may be capable of initiating an incomplete upgrade, evaluating the results therefrom, and initiating a complete upgrade. However, variations of upgrade process 200 may be implemented in the systems and sub-systems that may carry out the incomplete and complete upgrades. For example, other computing systems that may be considered a part of service environment 101 may perform the incomplete and complete upgrades.

Regardless, computing system 300, referred to in FIG. 3, may be representative of any such computing system or systems deployed within any environment and on which upgrade process 200 or variations thereof may be suitably implemented. Optionally, computing system 300 may also be suitable for implementing all of or portions of service environment 101. Examples of computing system 300 include server computers, mainframe computers, virtual machines, distributed computing systems, computing appliances, personal computers, mobile computers, desktop computers, laptop computers, tablet computers, and notebook computers, as well as any combination or variation thereof.

Computing system 300 includes processing system 301, storage system 303, software 305, and communication interface 307. Computing system 300 also includes user interface 309, although user interface 309 is optional. Processing system 301 is operatively coupled with storage system 303, communication interface 307, and user interface 309. Processing system 301 loads and executes software 305 from storage system 303. When executed by computing system 300 in general, and processing system 301 in particular, software 305 directs computing system 300 to operate as described herein for upgrade process 200 or variations thereof. Computing system 300 may optionally include additional devices, features, or functionality not discussed here for purposes of brevity and clarity.

Referring still to FIG. 3, processing system 301 may comprise a microprocessor and other circuitry that retrieves and executes software 305 from storage system 303. Processing system 301 may be implemented within a single processing device but may also be distributed across multiple processing devices or sub-systems that cooperate in executing program instructions. Examples of processing system 301 include general purpose central processing units, application specific processors, and logic devices, as well as any other type of processing device, combinations of processing devices, or variations thereof.

Storage system 303 may comprise any storage media readable by processing system 301 and capable of storing software 305. Storage system 303 may include volatile and nonvolatile, removable and non-removable media implemented in any method or technology for storage of information, such as computer readable instructions, data structures, program modules, or other data. Storage system 303 may be implemented as a single storage device but may also be implemented across multiple storage devices or sub-systems co-located or distributed relative to each other. Storage system 303 may comprise additional elements, such as a controller, capable of communicating with processing system 301.

Examples of storage media include random access memory, read only memory, magnetic disks, optical disks, flash memory, virtual memory and non-virtual memory, magnetic cassettes, magnetic tape, magnetic disk storage or other magnetic storage devices, or any other medium which can be used to store the desired information and that may be accessed by an instruction execution system, as well as any combination or variation thereof, or any other type of storage media. In some implementations, the storage media may be a non-transitory storage media. In some implementations, at least a portion of the storage media may be transitory. It should be understood that in no case is the storage media a propagated signal.

Software 305 may be implemented in program instructions and among other functions may, when executed by computing system 300, direct computing system 300 to

initiate an incomplete upgrade of a plurality of service units within a service environment, evaluate an upgrade health of each of the plurality of service units based at least in part on results of the incomplete upgrade, and initiate a complete upgrade of the service environment based at least in part on the upgrade health of each of the plurality of service units. Software 305 may include additional processes, programs, or components, such as operating system software or other application software. Software 305 may also comprise firmware or some other form of machine-readable processing instructions executable by processing system 301.

In at least one implementation, the program instructions may include evaluation instructions that, when executed by a computing system, direct the computing system to at least initiate an incomplete upgrade of a plurality of service units within a service environment and evaluate an upgrade health of each of the plurality of service units based at least in part on results of the incomplete upgrade. The program instructions may also include upgrade instructions that, when executed by the computing system, direct the computing system to at least initiate a complete upgrade of the service environment based at least in part on the upgrade health of each of the plurality of service units.

In general, software 305 may, when loaded into processing system 301 and executed, transform processing system 301, and computing system 300 overall, from a general-purpose computing system into a special-purpose computing system customized to facilitate technology upgrades as described herein for each implementation. Indeed, encoding software 305 on storage system 303 may transform the physical structure of storage system 303. The specific transformation of the physical structure may depend on various factors in different implementations of this description. Examples of such factors may include, but are not limited to the technology used to implement the storage media of storage system 303 and whether the computer-storage media are characterized as primary or secondary storage.

For example, if the computer-storage media are implemented as semiconductor-based memory, software 305 may transform the physical state of the semiconductor memory when the program is encoded therein. For example, software 305 may transform the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate this discussion.

It should be understood that computing system 300 is generally intended to represent a computing system with which software 305 is deployed and executed in order to implement upgrade process 200 (and variations thereof) and optionally all or portions of service environment 101. However, computing system 300 may also represent any computing system on which software 305 may be staged and from where software 305 may be distributed, transported, downloaded, or otherwise provided to yet another computing system for deployment and execution, or yet additional distribution.

Referring again to FIG. 1, through the operation of computing system 300 employing software 305, transformations may be performed with respect to service environment 101. As an example, service environment 101 could be considered transformed from one state to another when subject to upgrade process 200 or variations thereof. In a first state, an incomplete upgrade may be performed to evaluate the upgrade health of service units. A complete upgrade may then be performed to the service units based on their respective upgrade health, thereby changing service environment 101 to a different state.

Referring again to FIG. 3, communication interface 307 may include communication connections and devices that allow for communication between computing system 300 and other computing systems not shown over a communication network or collection of networks (not shown). Examples of connections and devices that together allow for inter-system communication may include network interface cards, antennas, power amplifiers, RF circuitry, transceivers, and other communication circuitry. The aforementioned network, connections, and devices are well known and need not be discussed at length here.

User interface 309 may include a mouse, a voice input device, a touch input device for receiving a gesture from a user, a motion input device for detecting non-touch gestures and other motions by a user, and other comparable input devices and associated processing elements capable of receiving user input from a user. Output devices such as a display, speakers, printer, haptic devices, and other types of output devices may also be included in user interface 309. The aforementioned user input devices are well known in the art and need not be discussed at length here. User interface 309 may also include associated user interface software executable by processing system 301 in support of the various user input and output devices discussed above. Separately or in conjunction with each other and other hardware and software elements, the user interface software and devices may provide a graphical user interface, a natural user interface, or any other kind of user interface.

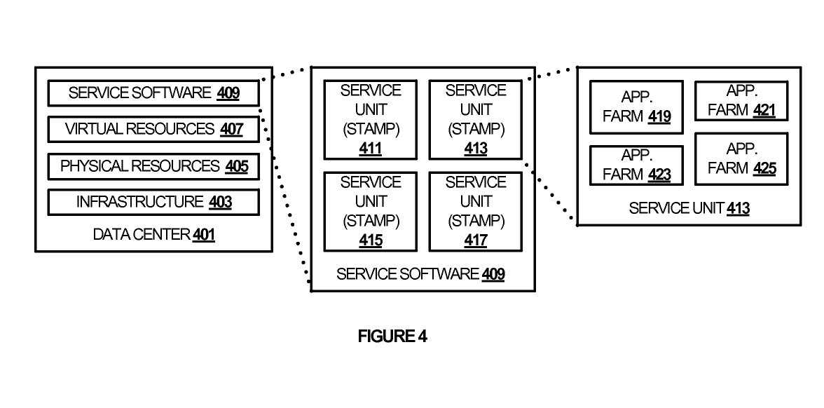

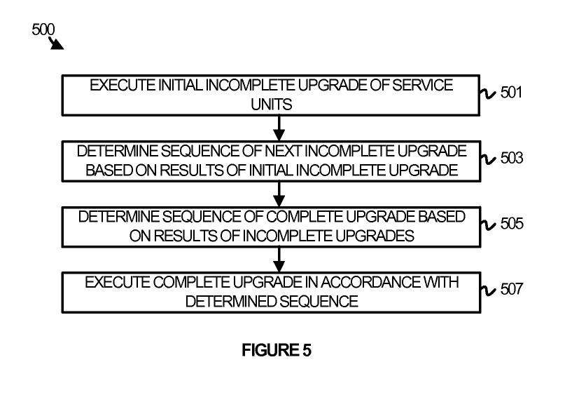

FIG. 4 illustrates data center 401 in an implementation, while FIG. 5 illustrates an upgrade process 500 for upgrading components in data center 401. The following discussion of FIG. 4 will make parenthetical reference to the steps illustrated by upgrade process 500 for purposes of clarity. Note the additional steps may be considered within the scope of this disclosure.

Data center 401 includes infrastructure 403, physical resources 405, virtual resources 407, and service software 409. From time to time, various aspects of data center 401 may be upgraded. For example, new versions of service software 409 or patches to service software 409 may be developed. Accordingly, upgrade process 500 may be employed to intelligently determine in order which the upgrade to service software 409 may occur.

In particular, upgrade process 500 calls for initially executing an incomplete upgrade to service units (step 501). Referring again to FIG. 4, service software 409 may be defined in terms of service units, or stamps, representative of a unit of scale at which the service provided by service software 409 may be scaled. In this implementation, one deployment of service software 409 includes service unit 411, service unit 413, service unit 415, and service unit 417. Note that additional deployments of service software 409 are possible. Note also that greater or lesser numbers of service units are possible and should be considered within the scope of this disclosure.

The incomplete upgrade may involve a number of upgrade tasks typically performed when upgrading software. However, the tasks involved in the incomplete upgrade may exclude at least one task that would otherwise be performed in the event of a complete upgrade. For example, a complete upgrade may culminate by shifting live traffic from some service units to cloned units cloned from the service units. Thus, the incomplete upgrade may exclude the step of shifting traffic. Others steps provided in either an incomplete or complete upgrade include, for example, provisioning additional physical resources when necessary, provisioning additional virtual resources when necessary, backing up data, moving data, and installing or otherwise providing the upgraded software. Note that other tasks are possible in addition to or in place of the tasks disclosed herein.

With respect to FIG. 4, at least one task involved in the incomplete upgrade includes provisioning application farms with the portion or components of service software 409 relevant to the upgrade. In FIG. 4, service unit 413, representative of service units 411, 415, and 417, includes application farm 419, application farm 421, application farm 423, and application farm 425. Application farms 419, 421, 423, and 425 are representative of various software components, and possibly hardware or virtual components, being upgraded as part of the upgrade to service software 409. For example, application farm 419 may be representative of multiple instances of an application that provides at least a portion of the service delivered as service software 409. Likewise, application farms 421, 423, and 425 may each be representative of multiple instances of different applications that provide other portions of the service. Examples of software farms 419, 421, 423, and 425 include content farms, federated services farms, authentication and authorization farms, and sequential query language (SQL) farms. Other farms in addition to or in place of those discussed herein are possible and may be considered within the scope of this disclosure.

A health of each of service units 411, 413, 415, and 417 may be determined based on results of the incomplete upgrade. The upgrade health may be determined based on a variety of factors, such as the ability for each of task involved in the incomplete upgrade to be completed successfully, partially, or not at all with respect to each service unit. Other factors may include the progress made against each task or the difficulty of completing each task when obstacles to its completion are encountered. A variety of indicators may be used to represent the upgrade health for each service unit, such as an alphanumeric representation, as well as any other suitable indicator.

In at least one implementation, a numeric score is calculated for each service unit that represents the health of the service unit with respect to potential upgrades. Each of the subset of tasks is assigned a factor. For instance, a farm deployment task may be assigned a factor F_{D} of 1, a content farm upgrade task may be assigned a factor F_{C} of 100-N, N representing a number of failed databases encountered when upgrading a content farm, and a federated farm upgrade task may be assigned a factor F_{S} of 1. A total score may then be calculated for each service unit. The total score may be a conditional score equal to the greater of 1 or the product of F_{D}, F_{C}, and F. In a different example, the total score may be the sum of F_{D}, F_{C}, and F_{S}. In either case, the result may be compared against a rule to determine whether or not a service unit may be upgraded or the order in which a service unit may be upgraded relative to other service units.

The factor for at least one of the tasks may then be weighted, such that a sum of the tasks provides a score that can be compared against similar scores calculated for other service units. In another implementation, each task is assigned a score within a range based on the progress made towards completing each task. The scores may again be summed and the sum provided as representative of the health of the subject service unit, comparable to other metrics for other service units. Note that other scores and ways to determine scores are possible and are not limited to those disclosed herein. Rather, a wide variety of scoring mechanisms, weighting mechanism, or measuring mechanisms, as well as any combination or variation thereof, may be deployed allowing for a readiness comparison between service units with respect to upgrades.

Next, the sequence of a next incomplete upgrade may be determined from the upgrade health of each service unit (step 503). Note that this step is optional and may be excluded from some implementations. For example, the service unit having the worst health with respect to upgradability may be positioned first in the next incomplete upgrade so as to discover, fix, or otherwise eliminate any obstacles to a complete upgrade with respect to that service unit. As each incremental incomplete upgrade is executed, additional intelligence can be gained that can be used when formulating incomplete upgrade schedules.

Eventually, a complete upgrade may be called for, such as when a new version or patch is released. The sequence for the complete upgrade may also be determined based on the upgrade health of each of service units 411, 413, 415, and 417 as determined from results of the incomplete upgrade or upgrades (step 505). In some operational scenarios, the sequence may generally proceed from the service unit with the best upgrade health to the service unit with the worst upgrade health. In other operational scenarios, the sequence may generally proceed from the service unit with the worst upgrade health to the service unit with the best upgrade health. In yet other scenarios, the availability of physical and virtual resources may be considered when determining upgrade sequences. Other sequences, combinations of sequences, or variations thereof may be considered within the scope of this disclosure.

Having determined a sequence for the complete upgrade, the complete upgrade may be executed in order to upgrade service software 409 (step 507). In addition to the upgrade tasks involved in the incomplete upgrade process, at least one other task may be included in the complete upgrade. For example, the complete upgrade may include shifting traffic from previous instances of stamps or application farms to the upgraded versions of the stamps of application farms.

In an operational example, an automatic scheduler of dry runs, or incomplete upgrades, may be deployed to trigger real upgrades of stamps throughout a service, such as SharePoint® Online from Microsoft®. The automatic scheduler may be useful to any application or service hosted within a data center or other similar hosting environment whereby the applications may be subject to upgrades. Upgrades will start with the stamps having relatively good update health scores, as determined by the automatic scheduler based on dry run data.

In the event that issues are encountered during a real upgrade, the upgrade can pause with respect to the problematic stamp, but continue with or proceed to upgrading the next healthiest stamp. The upgrade can automatically return to the problematic stamp once the issue with that stamp has been resolved.

In some implementations which stamps are subject to upgrade, and thus which stamps are subject to dry runs, may be a configurable option. However, it is also possible to perform dry runs on every stamp in an installation such that, when an upgrade opportunity arises, the stamps can be upgraded in an optimal order.

Upgrades may be implemented using an upgrade daemon. The upgrade daemon performs automatic upgrades of stamps in a service. Stamps may be arranged in zones. As additional stamps are needed, zones can be added should the existing physical capability of a service environment be exceeded. Upgrades may occur in parallel across zones, but within zones may occur in series to ensure that minimum service levels are achieved.

The order in which stamps are selected for upgrade may be determined by the upgrade daemon employing logic that considers the health of each stamp. In particular, a stamp with the most recent successful dry run with respect to a current build version may be selected first for upgrade. Next, the stamps with the most successful dry run with respect to the most recent build version prior to the current builder version may be selected. Stamps without dry run results may be selected next, and finally, stamps without successfully dry runs may be selected. Note that a variety of other selection logic may be employed by the upgrade daemon and may not be limited to just the logic disclosed herein. For example, the size of a zone to which a stamp belongs may be a factor in its selection for upgrade. In another example, whether or not an upgrade has already begun within a zone to which a stamp belongs may be a factor.

In some implementations, each stamp may be subject to a series of dry runs. A first level of dry runs may discover issues that can be fixed. The second level of dry runs may discover issues that, until the previous issues were fixed, were undiscoverable. After some finite number of iterations, the health of the stamp may be considered sufficiently evaluated for purposes of scheduling complete upgrades. Note that each individual stamp may be subjected to a series of dry runs prior to moving on to other stamps. More likely, stamps will be subject to a series of dry runs in parallel. Combinations and variations of performing the dry runs in parallel and in series are also possible.

In yet other implementations, a final dry run may be performed just prior to performing an actual upgrade. For instance, a series of dry runs may be performed in order to evaluate the health of stamps and schedule the real upgrade to the stamps. Once the upgrade is scheduled and initiated, one last dry run may be performed in order to discover any last minute or over looked problems that may inhibit the real upgrade from completing successfully.

In addition to the health of each stamp, other factors that may be involved in scheduling complete upgrades include development schedules, such as when a new version of or patch to existing software will be ready for deployment, hardware resource availability, controlled downtime schedules, resource consumption limits, and upgrade progress information with respect to other upgrades.

In addition to scheduling when a stamp may be upgraded, the scheduling of individual upgrade tasks within a stamp upgrade is also possible. Whether a given upgrade task is a dependent task of an independent task may also factor into their scheduling. For example, all dependent tasks may be coordinated to start early in a stamp upgrade, while independent tasks can be scheduled in parallel with minimal impact to overall service or system performance. In a SharePoint® example, examples of dependent tasks include deploying a new content farm, running pre-validations, running upgraders, running post upgraders, and running post-validation steps. An example of an independent task is migrating database from a source content farm to a new content farm.

The functional block diagrams, operational sequences, and flow diagrams provided in the Figures are representative of exemplary architectures, environments, and methodologies for performing novel aspects of the disclosure. While, for purposes of simplicity of explanation, the methodologies included herein may be in the form of a functional diagram, operational sequence, or flow diagram, and may be described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

The included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. One or more computer readable media having stored thereon executable program instructions for facilitating technology upgrades, the program instructions comprising:
evaluation instructions that, when executed by a computing system, direct the computing system to at least initiate an incomplete upgrade of a plurality of service units within a service environment and evaluate an upgrade health of each of the plurality of service units based at least in part on results of the incomplete upgrade; and
upgrade instructions that, when executed by the computing system, direct the computing system to at least initiate a complete upgrade of the service environment based at least in part on the upgrade health of each of the plurality of service units.

2. The one or more computer readable media of claim 1 wherein to initiate the complete upgrade of the service environment based on the upgrade health of each of the service units the evaluation instructions direct the computing system to determine a sequence for the complete upgrade based on the upgrade health of each of the service units and initiate the complete upgrade to each of the service units according to the sequence.

3. The one or more computer readable media of claim 1 wherein the evaluation instructions further direct the computer system to determine a sequence for the incomplete upgrade of the plurality of service units based at least in part on previous results of a previous incomplete upgrade.

4. The one or more computer readable media of claim 1 wherein each of the plurality of service units comprises a stamp for providing a software service.

5. The one or more computer readable media of claim 4 wherein the stamp comprises a plurality of service farms, each of the plurality service farms comprising a different type of farm than others of the plurality of service farms.

6. The one or more computer readable media of claim 1 wherein the complete upgrade comprises a plurality of upgrade tasks and wherein the incomplete upgrade comprises only a subset of the plurality of upgrade tasks.

7. The one or more computer readable media of claim 6 wherein the plurality of upgrade tasks includes switching traffic from at least a portion of the plurality of service units to a plurality of cloned units cloned from the plurality of service units, wherein the plurality of incomplete upgrade tasks does not include switching the traffic.

8. One or more computer readable media having stored thereon program instructions for facilitating technology upgrades that, when executed by a computing system, direct the computing system to at least:
initiate an upgrade evaluation of a service environment comprising a plurality of stamps to evaluate an upgrade health of at least each of the plurality of stamps, the upgrade evaluation comprising a subset of a plurality of upgrade tasks initiated when performing an upgrade to the service environment;
generate an upgrade schedule to the service environment based on schedule information comprising the upgrade health of each of the plurality of stamps; and
initiate the upgrade to the service environment in accordance with at least the upgrade schedule.

9. The one or more computer readable media of claim 8 wherein the program instructions further direct the computer system to sequence the subset of the plurality of upgrade tasks based at least in part on previous results of a previous subset of the plurality of upgrade tasks.

10. The one or more computer readable media of claim 8 wherein each of the plurality of stamps comprises a plurality of processing resources and a plurality of application resources for providing a software service.

11. The one or more computer readable media of claim 8 wherein the plurality of upgrade tasks includes switching traffic from at least a portion of the plurality of service units to a plurality of cloned units cloned from the plurality of service units, wherein the subset of the plurality of upgrade tasks does not include switching the traffic.

12. The one or more computer readable media of claim 8 wherein the program instructions further direct the computing system to clone at least the portion of the plurality of service units.

13. The one or more computer readable media of claim 8 wherein the program instructions further direct the computing system to continue the upgrade to the service environment with respect to a next service unit of the plurality of service units upon encountering an obstacle to completing the upgrade to the service environment with respect to an initial service unit.

14. A method for facilitating technology upgrades in a data center comprising:
initiating an incomplete upgrade of a plurality of service units within a service environment;
evaluating an upgrade health of each of the plurality of service units based at least in part on results of the incomplete upgrade; and
initiating a complete upgrade of the service environment based at least in part on the upgrade health of each of the plurality of service units.

15. The method of claim 14 wherein the method further comprises determining a sequence for the complete upgrade based on the upgrade health of each of the service units and initiating the complete upgrade according to the sequence.

16. The method of claim 14 further comprising determining a sequence of the incomplete upgrade of the plurality of service units based at least in part on previous results of a previous incomplete upgrade.

17. The method of claim 14 wherein each of the plurality of service units comprises a plurality of processing resources and a plurality of application resources for providing a software service.

18. The method of claim 17 wherein the plurality of application resources comprises a plurality of service applications, each of the plurality applications farms comprising a different type of application than others of the plurality of service applications.

19. The method of claim 14 wherein the complete upgrade comprises a plurality of upgrade tasks and wherein the incomplete upgrade comprises only a subset of the plurality of upgrade tasks.

20. The method of claim 19 wherein the plurality of upgrade tasks includes switching traffic from at least a portion of the plurality of service units to a plurality of cloned units cloned from the plurality of service units, wherein the plurality of incomplete upgrade tasks does not include switching the traffic.
